(19) United States
(12) Patent Application Publication
(10) Pub. No.: US 2017/0278604 A1
(43) Pub. Date: Sep. 28, 2017

(54) RFeB SYSTEM SINTERED MAGNET

(71) Applicant: INTERMETALLICS CO., LTD., Nakatsugawa-shi, Gifu (JP)

(72) Inventors: Yasuhiro UNE, Nagoya-shi (JP); Hirokazu KUBO, Kasugai-shi (JP); Masato SAGAWA, Kyoto-shi (JP); Satoshi SUGIMOTO, Sendai-shi (JP); Masashi MATSUURA, Sendai-shi (JP); Michihide NAKAMURA, Nagoya-shi (JP)

(73) Assignee: INTERMETALLICS CO., LTD., Nakatsugawa-shi, Gifu (JP)

(21) Appl. No.: 15/503,814

(22) PCT Filed: Aug. 18, 2015
(86) PCT No.: PCT/JP2015/073064

§ 371 Date: Feb. 14, 2017

(30) Foreign Application Priority Data
Aug. 18, 2014 (JP) 2014-165953

(51) Int. Cl. H01F 1/057; C22C 38/10; C22C 38/06; H02K 1/02; B22F 3/16; B22F 9/02; H01F 41/02; C22C 38/16; C22C 38/00

(52) U.S. Cl. CPC H01F 1/0577; C22C 38/16; C22C 38/10; C22C 38/06; C22C 38/005; C22C 38/002; B22F 3/16; B22F 9/023; H01F 41/0266; H02K 1/02; B22F 2009/044

(57) ABSTRACT

An RFeB system sintered magnet which does not contain a heavy rare-earth element R^{H} (Dy, Tb and Ho) in a practically effective amount and yet is suited for applications in which the magnet undergoes a temperature increase during its use. The RFeB system sintered magnet contains at least one element selected from the group consisting of Nd and Pr as a rare-earth element R in addition to Fe and B while containing none of Dy, Tb and Ho, the magnet having a temperature characteristic value t₍₁₀₀₋₂₃₎ which satisfies −0.58<t₍₁₀₀₋₂₃₎<0, where t₍₁₀₀₋₂₃₎ is defined by the following equation:

$${t}_{( 100 - 23 )} = \frac{{H}_{cj} ( 100 ) - {H}_{cj} ( 23 )}{( 100 - 23 ) \times {H}_{cj} ( 23 )} \times 100$$

using H_{cj}(23) which is the value of the coercivity at a temperature of 23° C. and H_{cj}(100) which is the value of the coercivity at a temperature of 100° C.

### TECHNICAL FIELD

The present invention relates to an RFeB system sintered magnet containing R (rare-earth element), Fe (iron) and B (boron) as its principal components. In particular, the present invention relates to an RFeB system sintered magnet containing at least one element selected from the group consisting of Nd (neodymium) and Pr (praseodymium) as the principle rare-earth element R while containing none of Tb (terbium), Dy (dysprosium) and Ho (holmium) in a practically effective amount (these elements are hereinafter collectively called the “heavy rare-earth elements R^{H}”).

### BACKGROUND ART

An RFeB system sintered magnet is a permanent magnet produced by orienting and sintering an RFeB system alloy powder. This RFeB system sintered magnet, which was discovered in 1982 by Masato Sagawa et al., is characterized in that it has far better magnetic characteristics than the previously known permanent magnets and yet can be produced from comparatively abundant and inexpensive materials, i.e. rare earths, iron and boron.

It is expected that RFeB system sintered magnets will be increasingly in demand in various forms in the future, such as permanent magnets for motors used in home electrical appliances (e.g. air conditioners) or motors used in automobiles (e.g. hybrid cars and electric cars). Motors used in home electrical appliances or automobiles become considerably hot during their use. Therefore, due to a reason which will be described later, RFeB system sintered magnets having a high level of coercivity H_{cj} have been in demand. The coercivity H_{cj} is an index which shows the intensity of the magnetic field that makes the magnetization of a magnet equal to zero when the magnetic field is applied to the magnet in the opposite direction to the direction of magnetization. The greater the value of the coercivity H_{cj} is, the higher the resistance to the reverse magnetic field is.

As the methods for increasing the coercivity in the RFeB system sintered magnet, the following methods have been known: The first method is to increase the amount of heavy rare-earth element R^{H} contained in the RFeB system sintered magnet (for example, see Patent Literature 1). The second method is to decrease the particle size of the alloy powder used as the raw material for the RFeB system sintered magnet and thereby decrease the size of the crystal grain in the RFeB system sintered magnet to be eventually obtained (for example, see Non Patent Literature 1). In Non Patent Literature 1, no heavy rare-earth element R^{H} is used.

### CITATION LIST

### Patent Literature

Patent Literature 1: WO 2013/100010 A

Patent Literature 2: WO 2006/004014 A

### Non Patent Literature

Non Patent Literature 1: Togo Fukada and six other authors, “Evaluation of the Microstructural Contribution to the Coercivity of Fine-Grained NdFeB Sintered Magnets”, Materials Transactions, The Japan Institute of Metals and Materials, Vol. 53, No. 11, pp. 1967-1971, issued on Oct. 25, 2012

### SUMMARY OF INVENTION

### Technical Problem

In motors used in home electrical appliances, automobiles and other applications, the temperature of the RFeB system sintered magnet changes during its use and increases to 100-180° C. Accordingly, in order to enhance the resistance to the reverse magnetic field over the entire range of temperatures during its use, the magnet needs to have a high level of coercivity H_{cj}. However, since the coercivity of RFeB system sintered magnet inevitably decreases with an increase in the temperature, it is also essential to minimize the rate of this decrease. The aforementioned RFeB system sintered magnet with the coercivity increased by the addition of a heavy rare-earth element R^{H} has excellent characteristics not only in that its coercivity at room temperature is high, but also in that the rate of decrease in the coercivity due to a temperature increase is low. However, the addition of the heavy rare-earth element R^{H} deteriorates some magnetic characteristics other than the coercivity H_{cj}, such as the residual magnetic flux density Bᵣ and maximum energy product (BH). Furthermore, since heavy rare-earth elements R^{H} are expensive and rare materials, the price of the RFeB system sintered magnet will increase and a stable supply of the magnet will be difficult.

The problem to be solved by the present invention is to provide an RFeB system sintered magnet which does not contain a heavy rare-earth element R^{H} in a practically effective amount and yet has satisfactory temperature characteristics with only a minor rate of decrease in the coercivity H which accompanies a temperature increase.

### Solution to Problem

In three kinds of samples of RFeB system sintered magnets with different sizes of the crystal grain described in Non Patent Literature 1, the value of the coercivity H_{cj} at each temperature increases with a decrease in the size of the crystal grain, whereas the rate of decrease in the coercivity H which accompanies a temperature increase does not show any significant change depending on the size of the crystal grain. However, an experiment (which will be described later) conducted by the present inventors has revealed that the rate of decrease in the coercivity H_{cj} which accompanies a temperature increase can be reduced by decreasing the size of the crystal grain of the RFeB system sintered magnet. Thus, the present invention has been created.

The present invention developed for solving the previously described problem is an RFeB system sintered magnet containing at least one element selected from the group consisting of Nd and Pr as a rare-earth element R in addition to Fe and B while containing none of Dy, Tb and Ho, the magnet characterized in that:

a temperature coefficient of coercivity t₍₁₀₀₋₂₃₎ satisfies −0.58<t₍₁₀₀₋₂₃₎<0, where t₍₁₀₀₋₂₃₎ is defined by the following equation:

$${t}_{( 100 - 23 )} = \frac{{H}_{cj} ( 100 ) - {H}_{cj} ( 23 )}{( 100 - 23 ) \times {H}_{cj} ( 23 )} \times 100$$

using H_{cj}(23) which is the value of the coercivity at a temperature of 23° C. and H_{cj}(100) which is the value of the coercivity at a temperature of 100° C.

In the present invention, the phrase “containing none of Dy, Tb and Ho” means that Dy, Tb and Ho, i.e. the heavy rare-earth element R^{H}, is not contained in a technically significant amount (or practically effective amount). This should be interpreted as including the case where the rare-earth element R^{H} as an unavoidable impurity may be contained in a quantity equal to or lower than 0.1 atomic percent of the entire amount of R.

The temperature coefficient of coercivity t₍₁₀₀₋₂₃₎ is defined so that a higher value (or smaller absolute value) of t₍₁₀₀₋₂₃₎ means a lower rate of decrease in the coercivity H_{cj} which accompanies a temperature increase and hence a more preferable characteristic for the purpose of the present invention. In the present invention, the temperature coefficient of coercivity t₍₁₀₀₋₂₃₎ is defined using the values of the coercivity H_{cj} at the two temperatures of 23° C. and 100° C. Regarding these temperatures, “23° C.” is an average value of the room temperature, while “100° C.” has been chosen for the following reason.

As already noted, a motor for automobiles or other applications may possibly undergo a temperature increase to approximately 180° C. during its use. Accordingly, it is also possible to use H_{cj}(180), i.e. the value of the coercivity at 180° C. However, as a result of an experiment conducted by the present inventors in which a temperature coefficient of coercivity t_{(Y-23)} defined by the following equation using the value of the coercivity at T degrees Celsius H_{cj}(T) was calculated,

$${t}_{( T - 23 )} = \frac{{H}_{cj} ( T ) - {H}_{cj} ( 23 )}{( T - 23 ) \times {H}_{cj} ( 23 )} \times 100$$

it was revealed that there was no reverse in the order of the temperature coefficient of coercivities of the samples when the temperature was within a range of 100° C.≦T≦180° C. In other words, a sample having a better temperature coefficient of coercivity t₍₁₀₀₋₂₃₎ at T=100° C. than the other samples also had better temperature coefficient of coercivities t_{(T-23)} than the other samples at any temperature within the entire range of 100° C.≦T≦180° C. Accordingly, calculating the temperature coefficient of coercivity t₍₁₀₀₋₂₃₎ is sufficient for knowing the order of temperature characteristics within the range of 100° C.≦T≦180° C. Additionally, since the value H_{cj}(100) of the coercivity at T=100° C. is the largest value within the aforementioned temperature range, the use of the value at this temperature decreases the error of the value of the coercivity H_{cj}(T) and consequently decreases the error of the temperature coefficient of coercivity.

In the case of the RFeB system sintered magnet described in Non Patent Literature 1, the highest value of the temperature coefficient of coercivity t₍₁₀₀₋₂₃₎ was −0.58 (a value obtained for sample A in FIG. 4B of the same literature). By comparison, an RFeB system sintered magnet created by the present inventors using the method which will be described later had the temperature coefficient of coercivity t₍₁₀₀₋₂₃₎ greater than the highest value in Non Patent Literature 1, i.e. −0.58, (or smaller than 0.58 in terms of the absolute value). On the other hand, the temperature coefficient of coercivity t₍₁₀₀₋₂₃₎ becomes smaller than zero, since the coercivity in an RFeB system sintered magnet decreases with an increase in the temperature.

It is possible to make the temperature coefficient of coercivity t₍₁₀₀₋₂₃₎ higher than 0.58 by making the grain size of the crystal grain constituting the RFeB system sintered magnet smaller than the conventional size. The smaller the grain size of the crystal grain is, the higher the temperature coefficient of coercivity t₍₁₀₀₋₂₃₎ can be. Practically, the temperature coefficient of coercivity t₍₁₀₀₋₂₃₎ can be easily increased to −0.53, and even further to −0.48 (i.e. within a range of −0.58<t₍₁₀₀₋₂₃)≦−0.48).

More specifically, the 50% cumulative diameter in the particle size distribution on an area basis D_{ave—S} calculated from the circle-equivalent diameters D of the crystal grains determined from a microscopic image of a section of the RFeB system sintered magnet is made to be equal to or smaller than 1 μm. The “circle-equivalent diameter D” is the diameter of a circle whose area corresponds to the cross-sectional area S determined by an image analysis for each main-phase crystal grain of the alloy powder in an image (microscopic image) acquired with an electron microscope or similar device (i.e. D=2×(S/π)^{0.5}). The “50% cumulative diameter in the particle size distribution on an area basis D_{ave—S}” is a circle-equivalent diameter on a microscopic image taken at a plane perpendicular to the axis of orientation of the sintered magnet, which is determined by accumulating the percentages of the sectional areas of the individual crystal grains in the total sectional area of all crystal grains in ascending order of the sectional area, and calculating the circle-equivalent diameter from the sectional area with which the accumulated value reaches 50%. In Non Patent Literature 1, a number-based average grain diameter is used, which is determined from the circle-equivalent diameter of the section of a crystal grain with which the number of crystal grains arrayed in ascending order of the sectional area reaches 50% of the total number of the crystal grains. The number-based average grain diameter places heavier weights on crystal grains with smaller areas and tends to have a smaller value than the 50% cumulative diameter in the particle size distribution on an area basis D_{ave—S}. Accordingly, although the smallest value of the number-based average grain diameter as set forth in Non Patent Literature 1 is 1 μm, the corresponding value of the 50% cumulative diameter in the particle size distribution on an area basis D_{ave—S} will be greater than 1 μm. By placing heavier weights on large-area crystal grains which significantly affect the magnetic characteristics, the 50% cumulative diameter in the particle size distribution on an area basis D_{ave—S} enables a more accurate evaluation than the number-based average grain diameter.

The RFeB system sintered magnet with the crystal grains having a 50% cumulative diameter in the particle size distribution on an area basis Dₐᵥₑ_{_{—s}} of equal to or smaller than 1 μm can be created by:

preparing a shaped body oriented by a magnetic field and subsequently sintering the shaped body, using an RFeB system alloy powder having a 50% cumulative diameter in the particle size distribution on an area basis D_{ave—S} of equal to or smaller than 0.7 μm, or more preferably equal to or smaller than 0.6 μm.

Such an RFeB system alloy powder can be obtained by performing an HDDR method (grain refining treatment) on a coarse powder of the raw material alloy to prepare coarse particles each having fine grains, pulverizing these coarse particles having fine grains by hydrogen decrepitation, and subsequently further pulverizing the same powder by a jet milling method using helium gas. The HDDR method is a technique in which the coarse powder of the raw material alloy is heated in a hydrogen atmosphere of 700-900° C. (“Hydrogenation”) to decompose the RFeB system alloy into the three phases of RH₂ (a hydride of rare-earth R), Fe₂B and Fe (“Decomposition”), after which the atmosphere is changed from hydrogen to vacuum, while maintaining the temperature, to desorb hydrogen from the RH₂ phase (“Desorption”) and thereby cause a recombination reaction among the phases within each particle of the coarse powder of the raw material alloy (“Recombination”).

To “prepare a shaped body” means preparing an object whose shape is exactly or roughly the same as that of the final product using an RFeB system alloy powder (this object is called the “shaped body”). The shaped body may be a compact produced by pressing an amount of RFeB system alloy powder into a shape that is exactly or roughly the same as that of the final product, or it may be an amount of RFeB system alloy powder (without being pressed) placed in a container (mold) having a cavity whose shape exactly or roughly the same as that of the final product (see Patent Literature 2). In the case where the shaped body is an amount of RFeB system alloy powder placed in a mold without being pressed, it is preferable to sinter the shaped body (i.e. the RFeB system alloy powder in the mold) without applying mechanical pressure to it. The omission of the application of the mechanical pressure to the RFeB system alloy powder from the process of preparing and sintering the shaped body provides the RFeB system sintered magnet with a high level of coercivity. This method also contributes to an increase in the coercivity in that it facilitates the handling of an RFeB system alloy powder with a small particle size (see Patent Literature 2).

### Advantageous Effects of the Invention

With the present invention, an RFeB system sintered magnet can be obtained which does not contain a heavy rare-earth element R^{H} in a practically effective amount and yet has satisfactory temperature characteristics with only a minor rate of decrease in the coercivity H_{cj} which accompanies a temperature increase. Therefore, the RFeB system sintered magnet according to the present invention is suited for applications in which the magnet undergoes a temperature increase during its use.

### BRIEF DESCRIPTION OF DRAWINGS

FIG. 1 is a chart illustrating one example of the method for producing an RFeB system sintered magnet according to the present invention.

FIG. 2 is a graph showing the grain diameter distribution for RFeB system sintered magnets of Present Example 1 as well as Comparative Examples 1 and 2, determined from the circle-equivalent diameters of the sectional areas of the crystal grains based on a microscopic image at a plane perpendicular to the axis of orientation.

FIG. 3 is a graph showing the temperature coefficient of coercivity t_{(T-23)} (including t₍₁₀₀₋₂₃₎ at T=100° C.) of RFeB system sintered magnets of Present Example 1 and Comparative Examples 1 and 2.

FIG. 4 is a graph showing the temperature coefficient of coercivity t_{(T-23)} (including t₍₁₀₀₋₂₃₎ at T=100° C.) of RFeB system sintered magnets of Present Example 2 and Comparative Examples 3-5.

### DESCRIPTION OF EMBODIMENTS

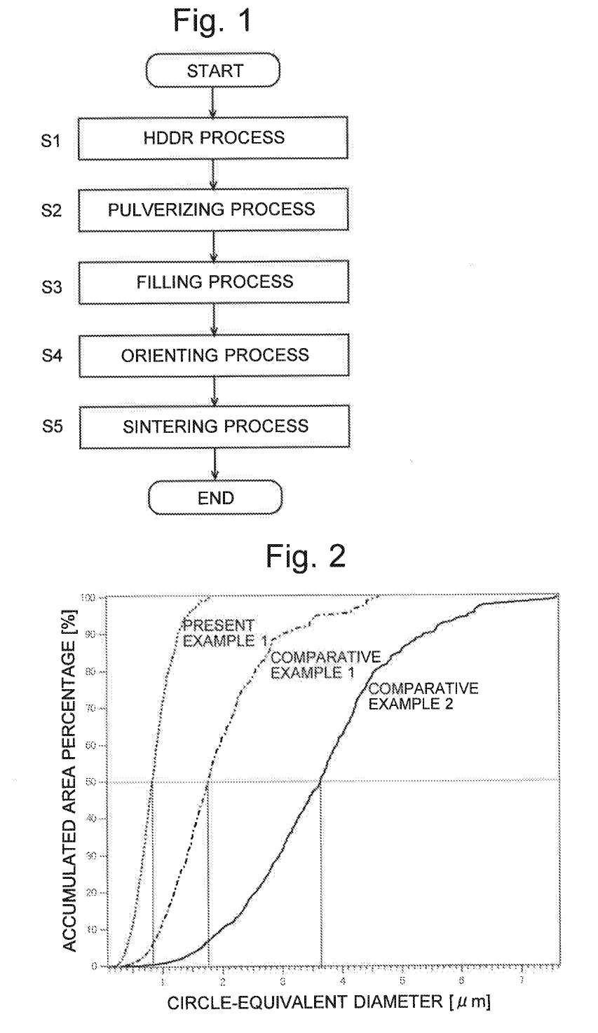

An embodiment of the RFeB system sintered magnet according to the present invention is described using FIGS. 1-4.

### EXAMPLE

Initially, one example of the method for producing the RFeB system sintered magnet according to the present invention is described using FIG. 1. The present production method includes five processes, i.e. the HDDR (Hydrogenation Disproportionation Desorption Recombination) process (Step S1), pulverizing process (Step S2), filling process (Step S3), orienting process (Step S4) and sintering process (Step S5). A lump of SC alloy prepared by a strip casting (SC) method is used as the raw material. The SC alloy lump is normally in the form of flakes with each side measuring a few millimeters. In the present embodiment, two kinds of SC alloy lumps, labeled “1” and “2”, with different compositions were used. Table 1 shows the composition of the SC alloy lumps 1 and 2. Neither the SC alloy lump 1 nor 2 contains heavy rare-earth elements R^{H}.

TABLE 1
Composition of SC Alloy Lumps (Unit: mass %)

| | Nd | Pr | B | Cu | Al | Co | Fe |
|---|---|---|---|---|---|---|---|
| SC Alloy Lump 1 | 27.5 | 4.15 | 1.00 | 0.50 | 0.23 | 0.96 | bal. |
| SC Alloy Lump 2 | 30.51 | 0.07 | 0.98 | 0.10 | 0.22 | 0 | bal. |

In the HDDR process, the SC alloy lump is initially heat treated under hydrogen gas pressure (“Hydrogenation”) to decompose the R₂Fe₁₄B compound (main phase) in the SC alloy lump into the three phases of RH₂, Fe₂B and Fe (“Disproportionation”). In the present example, the hydrogen gas pressure was set at 100 kPa, and the heat treatment was performed at a temperature of 950° C. (first heat treatment temperature) for 60 minutes. In the subsequent steps, while the temperature is maintained at a second heat treatment temperature which is lower than the first heat treatment temperature, the atmosphere is changed to vacuum to desorb hydrogen from the RH₂ phase (“Desorption”) and make this phase recombine with the Fe₂B phase and Fe phase (“Recombination”). In the present example, the second heat treatment temperature was set at 800° C., and the vacuum was maintained for 60 minutes. As a result, an RFeB system polycrystalline body with a 50% cumulative diameter in the particle size distribution on an area basis D_{ave—s} of approximately 0.6 μm is obtained.

In the pulverizing process, the RFeB system polycrystalline body is initially exposed to hydrogen gas without being heated from the outside. Then, the RFeB system polycrystalline body automatically generates heat and becomes brittle by occluding hydrogen. Next, the RFeB system polycrystalline body is coarsely pulverized with a mechanical crusher to obtain coarse powder. This coarse powder is subsequently introduced into a complete jet mill plant with helium gas circulation system (manufactured by Nippon Pneumatic Mfg. Co., Ltd., which is hereinafter called the “He jet mill”) and further pulverized. The He jet mill can generate a high-speed gas stream which is approximately three times as fast as the gas stream generated by an N₂ jet mill which uses nitrogen gas. The gas stream accelerates the material to high speeds, making the material collide repeatedly, whereby the material can be pulverized to a 50% cumulative diameter in the particle size distribution on an area basis D_{ave—s} of less than 1 μm, which cannot be achieved by the N₂ jet mill. In this manner, two samples of RFeB system alloy powder whose 50% cumulative diameter in the particle size distribution on an area basis D_{ave—s} did not exceed 0.7 μm were prepared, with D_{ave—S} being approximately 0.6 μm for the SC alloy lump 1 and approximately 0.67 μm for the SC alloy lump 2.

In the filling process, a mold having a cavity whose shape corresponds to that of the RFeB system sintered magnet as the final product is filled with the RFeB system alloy powder at a predetermined filling density (in the present example, 3.6 g/cm³). Subsequently, in the orienting process, a magnetic field (in the present example, a pulsed direct-current magnetic field of 5 T) is applied to the RFeB system alloy powder in the mold to orient the alloy powder. In the sintering process, the oriented alloy powder held in the mold is contained in a sintering furnace and heated under vacuum (in the present embodiment, at 880° C. for two hours) to sinter the powder. No mechanical pressure for molding the alloy powder is applied throughout the filling, orienting and sintering processes. By following the procedure described to this point, the RFeB system sintered magnet of the present embodiment is obtained. Hereinafter, the RFeB system sintered magnet created from the SC alloy lump 1 is called “Present Example 1”, while the one created from the SC alloy lump 2 is called “Present Example 2”.

As the comparative examples, RFeB system sintered magnets were additionally created using the RFeB system alloy powder prepared by pulverizing the same lot of the SC alloy lumps 1 and 2 as used for the present examples. The pulverization of the SC alloy lump was performed in such a manner that the 50% cumulative diameter in the particle size distribution on an area basis D_{ave —s} would be 1.4 μm (Comparative Example 1) and 3.1 μm (Comparative Example 2) for the SC alloy lump 1, as well as 1.32 μm (Comparative Example 3), 3.30 μm (Comparative Example 4) and 4.10 μm (Comparative Example 5) for the SC alloy lump 2. In these comparative examples, the HDDR process was omitted. In the pulverization process, the SC alloy was embrittled by the hydrogen occlusion method and then coarsely pulverized to prepare a coarse powder, which was further pulverized with the He jet mill to obtain the alloy powder. The filling, orienting, and sintering processes were performed by the same method as used for Present Examples 1 and 2.

The graph in FIG. 2 shows the grain diameter distribution for the RFeB system sintered magnet of Present Example 1 as well as those of Comparative Examples 1 and 2, determined from the circle-equivalent diameters of the sectional areas of the crystal grains based on a microscopic image at a plane perpendicular to the axis of orientation. The 50% cumulative diameter in the particle size distribution on an area basis D_{ave—S} calculated from this graph was 0.83 μm in Present Example 1, 1.78 μm in Comparative Example 1, and 3.65 μm in Comparative Example 2.

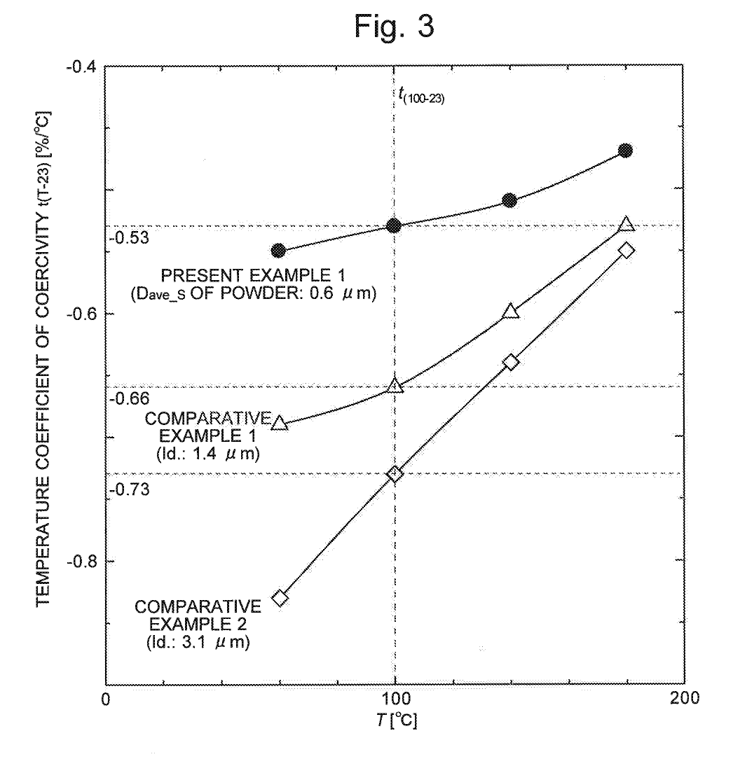

The graph in FIG. 3 shows the temperature coefficient of coercivities t_{(T-23)} at T=60° C., 100° C., 140° C. and 180° C. determined on the basis of the data of the coercivity H_{cj} acquired for the RFeB system sintered magnet of Present Example 1 as well as those of Comparative Examples 1 and 2. The data lying on the vertical broken line in this graph are the temperature coefficient of coercivities t₍₁₀₀₋₂₃₎ at T=100° C. defined in the present invention. Although the coercivity H_{cj} changes with the temperature, the vertical relationship (i.e. order) of the data of the Present Example 1 as well as the Comparative Examples 1 and 2 represented by the temperature coefficient of coercivity t_{(T-23)} is always the same and independent of T. The temperature coefficient of coercivity t₍₁₀₀₋₂₃₎ in Present Example 1 was −0.53, which is higher than −0.66 in Comparative Example 1, −0.73 in Comparative Example 2, and −0.58, i.e. the highest value mentioned in Non Patent Literature 1. This result confirms that the RFeB system sintered magnet of Present Example 1 has better temperature characteristics than those of the Comparative Examples 1 and 2 as well as the one described in Non Patent Literature 1.

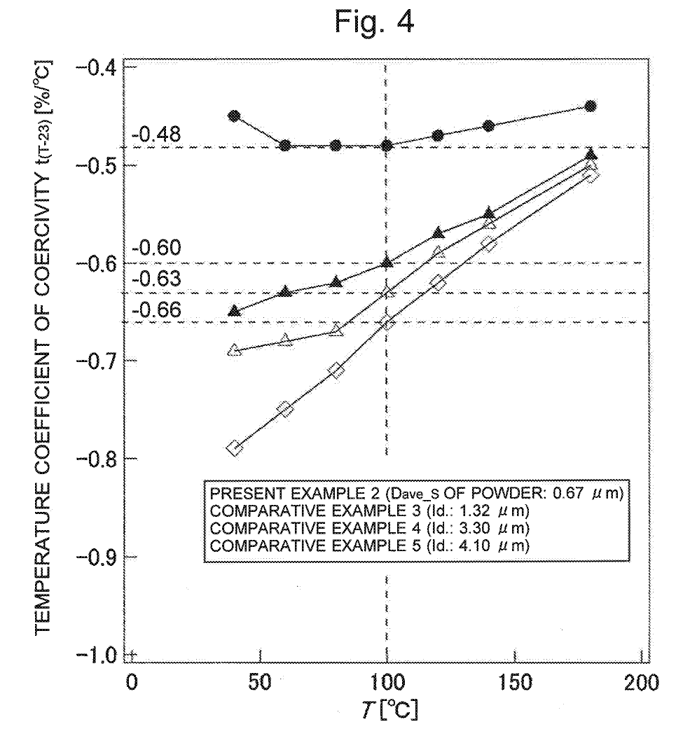

The graph in FIG. 4 shows the temperature coefficient of coercivities t_{(T-23)} similarly determined for Present Example 2 and Comparative Examples 3-5. The temperature coefficient of coercivity t₍₁₀₀₋₂₃₎ in Present Example 2 was −0.48, which is higher than the values obtained in Comparative Examples 3-5 (−0.66 to −0.60) as well as the highest value mentioned in Non Patent Literature 1, −0.58. Furthermore, the temperature coefficient of coercivity t₍₁₀₀₋₂₃₎ in Present Example 2 is higher than the value in Present Example 1. The reason for this is because the content of Pr in Present Example 2 was 0.07 mass % and lower than the value in Present Example 1 (4.15 mass %).

1. An RFeB system sintered magnet containing at least one element selected from a group consisting of Nd and Pr as a rare-earth element R in addition to Fe and B while containing none of Dy, Tb and Ho, wherein:
a temperature coefficient of coercivity t₍₁₀₀₋₂₃₎ satisfies −0.58<t₍₁₀₀₋₂₃₎<0, where t₍₁₀₀₋₂₃₎ is defined by a following equation:
$${t}_{( 100 - 23 )} = \frac{{H}_{cj} ( 100 ) - {H}_{cj} ( 23 )}{( 100 - 23 ) \times {H}_{cj} ( 23 )} \times 100$$
using H_{cj}(23) which is a value of a coercivity at a temperature of 23° C. and H_{cj}(100) which is a value of the coercivity at a temperature of 100° C.

2. The RFeB system sintered magnet according to claim 1, wherein the temperature coefficient of coercivity t₍₁₀₀₋₂₃₎ is within a range of −0.58<t₍₁₀₀₋₂₃₎≦−0.48.

3. The RFeB system sintered magnet according to claim 1 wherein a 50% cumulative diameter in the particle size distribution on an area basis D_{ave—S} calculated from a circle-equivalent diameters D of crystal grains determined from a microscopic image of a section of the RFeB system sintered magnet is equal to or smaller than 1 μm.

4. A method for producing the RFeB system sintered magnet according to claim 1, comprising steps of:
preparing a shaped body oriented by a magnetic field and subsequently sintering the shaped body, using an RFeB system alloy powder having a 50% cumulative diameter in the particle size distribution on an area basis D_{ave—s} of equal to or smaller than 0.7 μm.

5. The method for producing the RFeB system sintered magnet according to claim 4, wherein the RFeB system alloy powder is prepared by performing an HDDR on a coarse powder of the raw material alloy to prepare coarse particles each having fine grains, pulverizing these coarse particles having fine grains by hydrogen decrepitation, and subsequently further pulverizing the same powder by a jet milling method using helium gas.

6. The RFeB system sintered magnet according to claim 2, wherein a 50% cumulative diameter in the particle size distribution on an area basis D_{ave—S} calculated from a circle-equivalent diameters D of crystal grains determined from a microscopic image of a section of the RFeB system sintered magnet is equal to or smaller than 1 μm.

7. A method for producing the RFeB system sintered magnet according to claim 2, comprising steps of:
preparing a shaped body oriented by a magnetic field and subsequently sintering the shaped body, using an RFeB system alloy powder having a 50% cumulative diameter in the particle size distribution on an area basis D_{ave—S} of equal to or smaller than 0.7 μm.

8. A method for producing the RFeB system sintered magnet according to claim 3, comprising steps of:
preparing a shaped body oriented by a magnetic field and subsequently sintering the shaped body, using an RFeB system alloy powder having a 50% cumulative diameter in the particle size distribution on an area basis D_{ave S} of equal to or smaller than 0.7 μm.

9. A method for producing the RFeB system sintered magnet according to claim 6, comprising steps of:
preparing a shaped body oriented by a magnetic field and subsequently sintering the shaped body, using an RFeB system alloy powder having a 50% cumulative diameter in the particle size distribution on an area basis D_{ave—S} of equal to or smaller than 0.7 μm.

10. The method for producing the RFeB system sintered magnet according to claim 7, wherein the RFeB system alloy powder is prepared by performing an HDDR on a coarse powder of the raw material alloy to prepare coarse particles each having fine grains, pulverizing these coarse particles having fine grains by hydrogen decrepitation, and subsequently further pulverizing the same powder by a jet milling method using helium gas.

11. The method for producing the RFeB system sintered magnet according to claim 8, wherein the RFeB system alloy powder is prepared by performing an HDDR on a coarse powder of the raw material alloy to prepare coarse particles each having fine grains, pulverizing these coarse particles having fine grains by hydrogen decrepitation, and subsequently further pulverizing the same powder by a jet milling method using helium gas.

12. The method for producing the RFeB system sintered magnet according to claim 9, wherein the RFeB system alloy powder is prepared by performing an HDDR on a coarse powder of the raw material alloy to prepare coarse particles each having fine grains, pulverizing these coarse particles having fine grains by hydrogen decrepitation, and subsequently further pulverizing the same powder by a jet milling method using helium gas.
